(19) United States
(12) Patent Application Publication
(10) Pub. No.: US 2011/0179364 A1
(43) Pub. Date: Jul. 21, 2011

(54) METHODS, SYSTEMS, AND COMPUTER PROGRAM PRODUCTS FOR AUTOMATING OPERATIONS ON A PLURALITY OF OBJECTS

(76) Inventor: Robert Paul Morris, Raleigh, NC (US)

(21) Appl. No.: 12/689,177

(22) Filed: Jan. 18, 2010

(51) Int. Cl. G06F 3/048

(52) U.S. Cl. 715/764

(57) ABSTRACT

Methods and systems are described for automating operations on a plurality of objects. In one aspect, a method and system receives, based on a user input detected by an input device, a do-for-each indicator; identifies a target application for the do-for-each indicator; and, in response to receiving the do-for-each indicator, instructs the target application to perform an operation on each object in a plurality of objects while each object is sequentially represented, on a display device, as selected.

### RELATED APPLICATIONS

This application is related to the following commonly owned U.S. patent applications, the entire disclosure of each being incorporated by reference herein: application Ser. No. 12/688,996 (Docket No 0073) filed on 2010, Jan. 18, entitled “Methods, Systems, and Program Products for Traversing Nodes in a Path on a Display Device”; and

Application Ser. No. 12/689,169 (Docket No 0080) filed on 2010, Jan. 18, entitled “Methods, Systems, and Program Products for Automatically Selecting Objects in a Plurality of Objects”.

### BACKGROUND

Graphical user interfaces (GUIs) have changed the way users interact with electronic devices. In particular, GUIs have made performing command or operations on many records, files, and other data objects much easier. For example, users can use point and click interfaces to open documents, a press of the delete key to delete a file, and a right click to access other commands. To operate on multiple data objects, such as files in a file folder, a user can press the <ctrl> key or <shift> key while clicking on multiple files to create a selection of more than one file. The user can then operate on all of the selected files via a context menu activated by, for example, a right-click; a “drag and drop” process with a pointing device to copy, move, or delete the files; and, of course, a delete key can be pressed to delete the files.

Prior to GUI's a user had to know where the names of numerous operations and had to know how to use matching expressions including wildcard characters to perform an operation on a group of data objects.

Despite the fact that electronic devices have automated many user tasks; performing operations on multiple data objects remains a task requiring users to repeatedly provide input to select objects and select operations. This can not only be tedious for some users, it can lead to health problems as reported incidences of repetitive motion disorders indicate. Press and hold operations are particularly unhealthy when repeated often over extended periods of time.

Operating on multiple objects presented on a graphical user interface remains user input intensive and repetitive. Accordingly, there exists a need for methods, systems, and computer program products for automating operations on a plurality of objects.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for automating operations on a plurality of objects. In one aspect the method includes, receiving, based on a user input detected by an input device, a do-for-each indicator by a target application configured to process a plurality of objects. The method further includes in response to receiving the do-for-each indicator: determining a first object in the plurality represented as selected on a display device; invoking, based on the selected first object, a first operation handler to perform a first operation; representing a second object in the plurality as selected on the display device after the first object is represented as selected; and invoking, based on the selected second object, a second operation handler to perform a second operation.

Further, a system for automating operations on a plurality of objects is described. The system includes an execution environment including an instruction processing machine configured to process an instruction included in at least one of an input router component an iterator component, a selection manager component, and an operation agent component. The system includes the input router component configured for receiving, based on a user input detected by an input device, a do-for-each indicator by a target application configured to process a plurality of objects. The system further includes the iterator component configured in to instruct, in response to receiving the do-for-each indicator, the selection manager component included in the system and configured for determining a first object in the plurality represented as selected on a display device; the operation agent component included in the system and configured for invoking, based on the selected first object, a first operation handler to perform a first operation; the selection manager component configured for representing a second object in the plurality as selected on the display device after the first object is represented as selected; and the operation agent component configured for invoking, based on the selected second object, a second operation handler to perform a second operation.

In another aspect, a method for automating operations on a plurality of objects is described that includes receiving, based on a user input detected by an input device, a do-for-each indicator. The method further includes identifying a target application for the do-for-each indicator. The method still further includes instructing, in response to receiving the do-for-each indicator, the target application to perform an operation on each object in a plurality of objects while each object is sequentially represented on a display device as selected.

Still further, a system for automating operations on a plurality of objects is described that includes an execution environment including an instruction processing machine configured to process an instruction included in at least one of an input router component and an iterator component. The system includes the input router component configured for receiving, based on a user input detected by an input device, a do-for-each indicator. The system includes the iterator component configured for identifying a target application for the do-for-each indicator. The system still further includes the iterator component configured for instructing, in response to receiving the do-for-each indicator, the target application to perform an operation on each object in a plurality of objects while each object is sequentially represented on a display device as selected.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for automating operations on a plurality of objects according to an aspect of the subject matter described herein;

FIG. 3 is a block a diagram illustrating an arrangement of components for automating operations on a plurality of objects according to another aspect of the subject matter described herein;

FIG. 4a is a block a diagram illustrating an arrangement of components for automating operations on a plurality of objects according to another aspect of the subject matter described herein;

FIG. 4b is a block a diagram illustrating an arrangement of components for automating operations on a plurality of objects according to another aspect of the subject matter described herein;

FIG. 5a is a block a diagram illustrating an arrangement of components for automating operations on a plurality of objects according to another aspect of the subject matter described herein.

FIG. 5b is a block a diagram illustrating an arrangement of components for automating operations on a plurality of objects according to another aspect of the subject matter described herein.

FIG. 6 is a network diagram illustrating an exemplary system for automating operations on a plurality of objects according to an aspect of the subject matter described herein;

FIG. 7 is a diagram illustrating a user interface presented by a display according to an aspect of the subject matter described herein; and

FIG. 8 is a flow diagram illustrating a method for automating operations on a plurality of objects according to an aspect of the subject matter described herein.

### DETAILED DESCRIPTION

Prior to describing the subject matter in detail, an exemplary device included in an execution environment that may be configured according to the subject matter is described. An execution environment is a configuration of hardware and, optionally, software that may be further configured to include an arrangement of components for performing a method of the subject matter described herein.

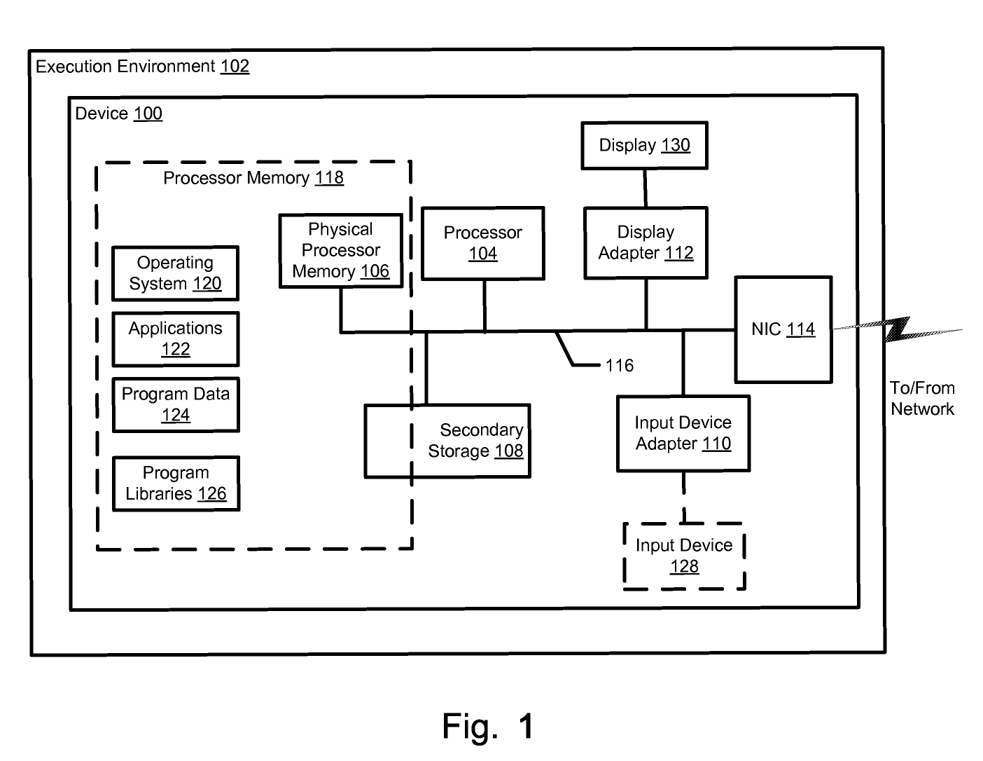

Those of ordinary skill in the art will appreciate that the components illustrated in FIG. 1 may vary depending on the execution environment implementation. An execution environment includes or is otherwise provided by a single device or multiple devices, which may be distributed. An execution environment typically includes both hardware and software components, but may be a virtual execution environment including software components operating in a host execution environment. Exemplary devices included in or otherwise providing suitable execution environments for configuring according to the subject matter include personal computers, servers, hand-held and other mobile devices, multiprocessor systems, consumer electronic devices, and network-enabled devices such as devices with routing and/or switching capabilities.

With reference to FIG. 1, an exemplary system for configuring according to the subject matter disclosed herein includes hardware device 100 included in execution environment 102. Device 100 includes an instruction processing unit illustrated as processor 104, physical processor memory 106 including memory locations that are identified by a physical address space of processor 104, secondary storage 108, input device adapter 110, a presentation adapter for presenting information to a user illustrated as display adapter 112, a communication adapter for communicating over a network such as network interface card (NIC) 114, and bus 116 that operatively couples elements 104-114.

Bus 116 may comprise any type of bus architecture. Examples include a memory bus, a peripheral bus, a local bus, a switching fabric, a network, etc. Processor 104 is an instruction execution machine, apparatus, or device and may comprise a microprocessor, a digital signal processor, a graphics processing unit, an application-specific integrated circuit (ASIC), a field programmable gate array (FPGA), etc.

Processor 104 may be configured with one or more memory address spaces in addition to the physical memory address space. A memory address space includes addresses that identify corresponding locations in a processor memory. An identified location is accessible to a processor processing an address that is included in the address space. The address is stored in a register of the processor and/or identified in an operand of a machine code instruction executed by the processor.

FIG. 1 illustrates that processor memory 118 may have an address space including addresses mapped to physical memory addresses identifying locations in physical processor memory 106. Such an address space is referred to as a virtual address space, its addresses are referred to as virtual memory addresses, and its processor memory is known as a virtual processor memory. A virtual processor memory may be larger than a physical processor memory by mapping a portion of the virtual processor memory to a hardware memory component other than a physical processor memory. Processor memory 118 illustrates a virtual processor memory mapped to physical processor memory 106 and to secondary storage 108. Processor 104 may access physical processor memory 106 without mapping a virtual memory address to a physical memory address.

Thus at various times, depending on the address space of an address processed by processor 104, the term processor memory may refer to physical processor memory 106 or a virtual processor memory as FIG. 1 illustrates.

Program instructions and data are stored in physical processor memory 106 during operation of execution environment 102. In various embodiments, physical processor memory 106 includes one or more of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Processor memory may also include nonvolatile memory technologies such as nonvolatile flash RAM (NVRAM), ROM, or disk storage. In some embodiments, it is contemplated that processor memory includes a combination of technologies such as the foregoing, as well as other technologies not specifically mentioned.

In various embodiments, secondary storage 108 includes one or more of a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide volatile and/or nonvolatile storage of computer readable instructions, data structures, program components and other data for the execution environment 102. As described above, when processor memory 118 is a virtual processor memory, at least a portion of secondary storage 108 is addressable via addresses within a virtual address space of the processor 104.

A number of program components may be stored in secondary storage 108 and/or in processor memory 118, including operating system 120, one or more applications programs (applications) 122, program data 124, and other program code and/or data components as illustrated by program libraries 126.

Execution environment 102 may receive user-provided commands and information via input device 128 operatively coupled to a data entry component such as input device adapter 110. An input device adapter may include mechanisms such as an adapter for a keyboard, a touch screen, a pointing device, etc. An input device included in execution environment 102 may be included in device 100 as FIG. 1 illustrates or may be external (not shown) to the device 100. Execution environment 102 may support multiple internal and/or external input devices. External input devices may be connected to device 100 via external data entry interfaces supported by compatible input device adapters. By way of example and not limitation, external input devices may include a microphone, joystick, game pad, satellite dish, scanner, or the like. In some embodiments, external input devices may include video or audio input devices such as a video camera, a still camera, etc. Input device adapter 110 receives input from one or more users of execution environment 102 and delivers such input to processor 104, physical processor memory 106, and/or other components operatively coupled via bus 116.

Output devices included in an execution environment may be included in and/or external to and operatively coupled to a device hosting and/or otherwise included in the execution environment. For example, display 130 is illustrated connected to bus 116 via display adapter 112. Exemplary display devices include liquid crystal displays (LCDs), light emitting diode (LED) displays, and projectors. Display 130 presents output of execution environment 102 to one or more users. In some embodiments, a given device such as a touch screen functions as both an input device and an output device. An output device in execution environment 102 may be included in device 100 as FIG. 1 illustrates or may be external (not shown) to device 100. Execution environment 102 may support multiple internal and/or external output devices. External output devices may be connected to device 100 via external data entry interfaces supported by compatible output device adapters. External output devices may also be connected to bus 116 via internal or external output adapters. Other peripheral output devices, not shown, such as speakers and printers, tactile, and motion producing devices may be connected to device 100. As used herein the term display includes image projection devices.

A device included in or otherwise providing an execution environment may operate in a networked environment using logical connections to one or more devices (not shown) via a communication interface. The terms communication interface and network interface are used interchangeably. Device 100 illustrates network interface card (NIC) 114 as a network interface included in execution environment 102 to operatively couple execution environment 102 to a network.

A network interface included in a suitable execution environment, such as NIC 114, may be coupled to a wireless network and/or a wired network. Examples of wireless networks include a BLUETOOTH network, a wireless personal area network (WPAN), a wireless 702.11 local area network (LAN), and/or a wireless telephony network (e.g., a cellular, PCS, or GSM network). Examples of wired networks include a LAN, a fiber optic network, a wired personal area network, a telephony network, and/or a wide area network (WAN). Such networking environments are commonplace in intranets, the Internet, offices, enterprise-wide computer networks and the like. In some embodiments, NIC 114 or a functionally analogous component includes logic to support direct memory access (DMA) transfers between processor memory 118 and other devices.

In a networked environment, program components depicted relative to execution environment 102, or portions thereof, may be stored in a remote storage device, such as, on a server. It will be appreciated that other hardware and/or software to establish a communications link between the device illustrated by device 100 and other network devices may be included.

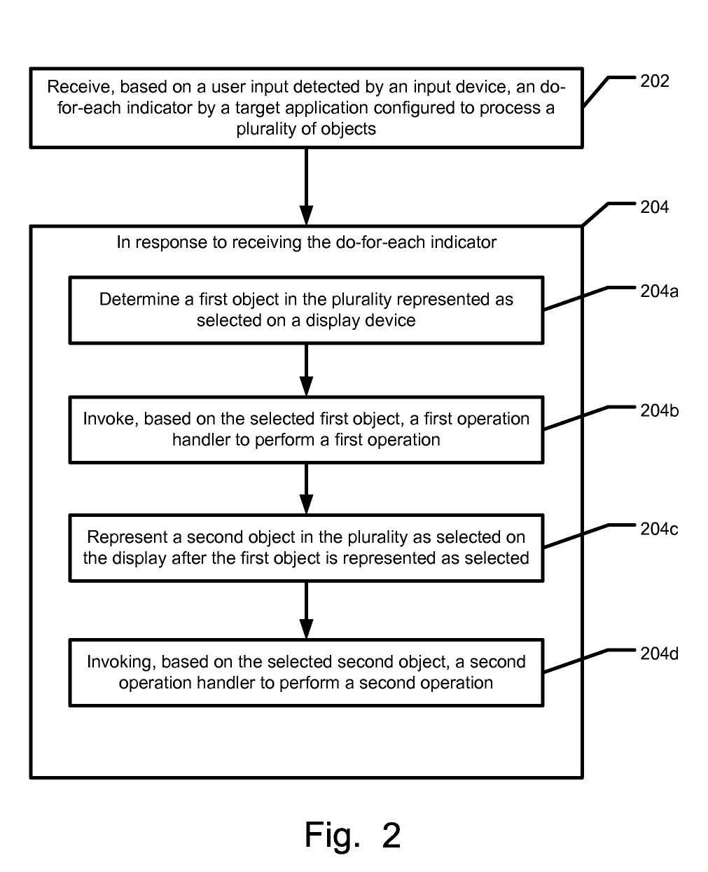

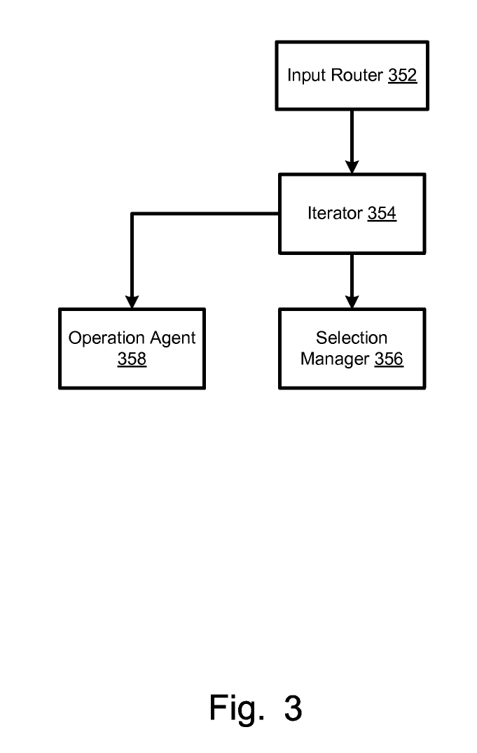

FIG. 2 is a flow diagram illustrating a method for automating operations on a plurality of objects according to an exemplary aspect of the subject matter described herein. FIG. 3 is a block diagram illustrating an arrangement of components for automating operations on a plurality of objects according to another exemplary aspect of the subject matter described herein.

A system for automating operations on a plurality of objects includes an execution environment, such as execution environment 102, including an instruction processing machine, such as processor 104 configured to process an instruction included in at least one of an input router component, an iterator component, a selection manager component, and an operation agent component. The components illustrated in FIG. 3 may be adapted for performing the method illustrated in FIG. 2 in a number of execution environments. A general description is provided in terms of execution environment 102.

With reference to FIG. 2, block 202 illustrates the method includes receiving, based on a user input detected by an input device, a do-for-each indicator by a target application configured to process a plurality of objects. Accordingly, a system for automating operations on a plurality of objects includes means for receiving, based on a user input detected by an input device, a do-for-each indicator by a target application configured to process a plurality of objects. For example, as illustrated in FIG. 3, a input router component 352 is configured for receiving, based on a user input detected by an input device, a do-for-each indicator by a target application configured to process a plurality of objects.

The arrangement of component in FIG. 3 and analogs of the arrangement may operate in various execution environments, such as execution environment 102. A user input detected by input device 128 may be processed by various components operating in execution environment 102. The processing results in data received by and/or otherwise detected as an indicator by input router component 352. For example, input device adapter 110, operating system 120, and/or one or more routines in program library 126 may process input information based on the user input detected by input device 128.

One or more particular indicators may each be defined to be a do-for-each indicator and/or do-for-each indicators by the arrangement of components in FIG. 3 and/or analogs of the arrangement. An indicator may be defined to be a do-for-each indicator based on a value identified by the indicator and/or based on a context in which an indicator is received and/or otherwise detected.

For example, input device 128 may detect a user press and/or release of an <enter> key on a keyboard. A first detected user interaction with the <enter> key may result in input router component 352 receiving a command or operation indicator for a an object represented by a user interface element on display 130 indicating the object is selected or has input focus. A second or a third interaction with the <enter> key in a specified period of time may be defined to be a do-for-each indicator detectable by input router component 352. Thus various user inputs and patterns of inputs detected by one or more input devices may be defined as do-for-each indicators detected by the arrangement of components in FIG. 3 and its analogs.

Alternatively or additionally, a user input may be detected by an input device operatively coupled to a remote device. Input information based on the user detected input may be sent in a message via a network and received by a network interface, such as NIC 114, operating in execution environment 102 hosting input router component 352. Thus, input router component 352 may detect a do-for-each indicator based on a message received from a remote device via a network.

In various aspects, a do-for-each indicator may include and/or otherwise identify additional information such an operation indicator identifying a particular operation to perform on the plurality of objects. Alternatively or additionally a default operation indicator may be identified indicating a default operation to perform on each object. A default operation may be identified based on an attribute of each object such as its type. Other attributes and combinations of attributes may be associated with various operations and may be identified by additional information included in and/or associated with a detected do-for-each indicator.

A do-for-each indicator may be received by input router component 352 within a specified time period prior to receiving an operation indicator, at the same time an operation indicator is received, and/or within a specified period after receiving an operation indicator.

Additional information other than operation indicator(s) maybe be included and/or otherwise associated with a do-for-each indicator. For example, a do-for-each indicator may include and/or reference a number. The number may identify the number of objects in the plurality of objects. A number may identify a maximum number of objects to iterate through performing corresponding operations in response to receiving the do-for-each indicator. A number may identify a minimum number of objects in the plurality to iterate over performing operations. A do-for-each indicator may identify one or more numbers for one or more purposes.

In another aspect, a do-for-each indicator may include and/or otherwise identify a matching criteria for identifying objects in the plurality to iterate through and perform associated operations. For example, a matching criteria may identify a type, such as a file type; a role such as a security role assigned to a person; a threshold time of creation; and or a size.

In still another aspect, a do-for-each indicator may identify more than one matching criteria for more than one purpose. For example, a matching criteria may be associated with and/or otherwise identified by a do-for-each indicator to identify a first object in the plurality and/or to identify a last object in the plurality. Thus, a do-for-each indicator may identify a starting object and an ending object in the process of performing operations based on the objects in the plurality. Further a do-for-each indicator may be associated with or otherwise identify an ordering criteria for ordering the objects and thus the ordering the operations to perform.

An object is tangible, represents a tangible thing, and/or has a tangible representation. Thus, the term object may be used interchangeably with terms for things objects are, things objects represent, and/or representations of objects. For example, in a file system explorer window pane in a GUI presented on a display device, terms used interchangeably with object include file, folder, container, node, directory, document, image, video, application, program, and drawing. In other applications other terms may be used interchangeably depending on the other applications.

Returning to FIG. 2, block 204 illustrates a number of sub-blocks performed in response to receiving the do-for-each indicator including sub-block 204a illustrating that the method includes determining a first object in the plurality represented as selected on a display device. Accordingly, a system for automating operations on a plurality of objects includes means for determining a first object in the plurality represented as selected on a display device, in response to receiving the do-for-each indicator. For example, as illustrated in FIG. 3, a selection manager component 356 is configured for determining a first object in the plurality represented as selected on a display device, in response to receiving the do-for-each indicator.

Fig. illustrates iterator component 354 operatively coupled to input router component 352. Iterator component 354 may receive the detected do-for-each indicator and/or information identified by, based on, and/or otherwise associated with the detected do-for-each indicator via interoperation with input router component 352. The interoperation and information exchange may be direct or indirect through one or more other components in an execution environment, such as execution environment 102. The interoperation and information exchange is performed in response to receiving and/or otherwise detecting the do-for-each indicator by input router component 352.

Iterator component 354 may instruct and/or otherwise provide for other components in a given execution environment to carry out portions of the method illustrated in FIG. 2 as sub-blocks of block 204. In response to receiving the do-for-each indicator, iterator component 354 instructs and/or otherwise provides for selection manager component 356 to determine a first object represented on display 130 as selected from the plurality of objects represented.

An object may be visually represented as selected based on one or more visual attributes that distinguish the object from unselected objects. For example, an object may be represented as selected based on a color, font, and/or enclosing user interface element. In an aspect a selected object may be distinguished from an unselected object based on its visibility. A selected object may be less transparent than unselected objects or unselected objects may not be visible. Some controls such as spin-boxes display only one object at time. The visible object is presented as selected by its appearance in a spin-box or other control as the only visible object.

Selection manager component 356 may determine a first selected object based on information received with and/or in addition to the do-for-each indicator. For example, a mouse click detected while a pointer is presented over an object may be defined to indicate the object is to be selected. The mouse click may be detected in correspondence with another input detectable as a do-for-each indicator. The mouse click by itself may be and/or result in the generation of both a selection indicator and a do-for-each indicator.

In an aspect, a do-for-each mode may be active. While the mode is active, a selection indicator for an object may be defined and thus detected as a do-for-each indicator. When the mode is inactive, the mouse click is not detected as a do-for-each indicator, but is detected as a selection indicator.

Selection manager component 356 may identify the first object based on an order of the objects in the plurality, a location on display 130 where an object is represented relative to other objects, and/or based on any number of other detectable attributes and conditions in a given execution environment. Examples of detectable attributes include content type, file type, record type, permission, user, group, time, location, size, age, last modified, and an attribute of a next and/or previous object,

If the first object is currently unselected, selection manager component 356 may provide for representing the first object as selected on display 130 as part of the determining process. Thus determining the first object may include determining for selecting. That is determining the first object may include determining an object to be represented as selected on a display device. Determining may further include representing the determined object, the first object, as selected on the display device in response to determining the object to be represented as selected. Selection manager component 356 may perform and/or otherwise provide for determining the first object to be selected and, subsequently, representing the first object as selected on the display.

In an aspect, selection manager component 356 may identify an object currently represented as selected and determine the selected object to be the first object.

Returning to FIG. 2, block 204 includes sub-block 204b illustrating that further in response to receiving the do-for-each indicator the method includes invoking, based on the selected first object, a first operation handler to perform a first operation. Accordingly, a system for automating operations on a plurality of objects further in response to receiving the do-for-each indicator includes means for invoking, based on the selected first object, a first operation handler to perform a first operation. For example, as illustrated in FIG. 3, an operation agent component 358 is configured for invoking, based on the selected first object, a first operation handler to perform a first operation, in response to receiving the do-for-each indicator.

In correspondence with determining the first object, iterator component 354 may call and/or otherwise instruct operation agent component 358 to identify and/or otherwise provide for identifying an operation to perform based on the selected first object. As described the operation may be identified by the do-for-each indicator and/or by information received along with the do-for-each indicator. In an aspect, multiple operation indicators may be included in and/or otherwise received along with a do-for-each indicator. The one or more operation indicators may identify one or more operations to perform based on each object in the plurality. Alternatively or additionally, iterator component 354 may identify operations in a sequential manner; identifying a first operation to perform for the selected first object, identifying a second operation to perform for a selected second object, and so on for each other object in the plurality of objects.

A first operation to perform based on the selected first object may be based on an attribute of the first object. For example, an “open” operation indicator may be identified as a default operation to perform. In an aspect, a first operation handler for performing an operation is based on the type of data included in the first object. When the first object is a video, a video player application may be identified as the operation handler associated with the first object. When the first object is a document template, a document editor application may be identified as the operation handler and may be invoked to create a new document based on the template first object and/or may open the template first object for editing the template.

In another example, a “view metadata” operation is identified by and/or received along with the do-for-each indicator. Since metadata may vary based on an object's type, role in a process, owner, and/or for various other reasons, one or more operation handlers may be identified for the first object and other objects in the plurality to display all or some of the metadata. The operation handlers may vary for each object.

In an aspect, as the first object is represented as selected on display 130, input router component 352 may receive an operation indicator based on a detected event such as another user input detected by an input device. Input router component 352 may communicate information to identify an operation handler to iterator component 354 for invoking the appropriate operation handler via operation agent component 358. Iterator component 354 and/or operation agent component 358 may identify an operation handler for the first object as well as subsequent objects represented as selected based on the operation indicator detected during the representation of the first object as selected. Input router component 352 may process one or more operation indicators detected while the first object is represented as selected.

Alternatively or additionally, input router component 352 may detect operation indicators while a subsequent object is represented as selected and provide the subsequently detected indicator(s) to iterator component 354 and/or operation agent component 358 for identifying an operation handler to invoke based on the object represented as selected when the indicator was detected. Iterator component 354 may invoke and/or otherwise instruct multiple operation handlers via one or more operation agent components 358 based on some or all operation indicators detected in association with processing the do-for-each indicator.

Alternatively or additionally, iterator component 354 and/or operation agent component 358 may stop using operation indicators detected in correspondence with preceding objects represented as selected and use only the most recently detected operation indicators. In a further aspect, input router component 352 may detect an operation indicator for the first and each subsequent object represented as selected. Each object may be represented as selected until an operation indicator is detected. An operation indicator may be a no operation or skip indicator. Alternatively or additionally, each object may be represented as selected for a specified time period and/or until some other specified event and/or condition is detected. If an operation indicator is not detected that corresponds to the object currently represented as selected, iterator component 354 and/or operation agent component 358 may identify a configured default operation which may be the skip or no-op operation.

Thus, iterator component 354 and/or operation agent component may receive an operation indicator based on a user input detected after detecting the do-for-each indicator. Iterator component 354 and/or operation agent component 358 may change a currently specified operation to perform on the first object or other object represented as selected by replacing the current operation indicator and/or adding the received operation indicator to a current active set of operation indicators.

In an aspect, the first object represented as selected may be an operation handler and may be invoked by operation agent component 358 for at least some subsequent objects presented as selected. Further, the plurality of objects may include multiple operation handlers and operation agent component 358 may invoke each operation handler based on an object subsequent to its representation as selected on display 130.

A same operation handler may be invoked for an object, such as the first object, and subsequent objects represented as selected to perform an operation based on a combination of the objects represented as selected. For example, an operation handler may combine objects in the plurality to create a new object of the same or different type as the objects operated on, may send each object to a particular receiver for storage and/or other processing, and/or may create a new collection of objects such as a new file system folder including the objects represented as selected.

Returning to FIG. 2, block 204 also includes sub-block 204c illustrating that also in response to receiving the do-for-each indicator the method includes representing a second object in the plurality as selected on the display device after the first object is represented as selected. Accordingly, a system for automating operations on a plurality of objects also in response to receiving the do-for-each indicator includes means for representing a second object in the plurality as selected on the display device after the first object is represented as selected. For example, as illustrated in FIG. 3, the selection manager component 356 is configured for representing a second object in the plurality as selected on the display device after the first object is represented as selected, in response to receiving the do-for-each indicator.

After the first object is represented as selected on display 130, iterator component 354 may invoke and/or otherwise instruct selection manager component 356 again to represent a second object in the plurality as selected on display 130. There may be period of overlap when both the first and second object are represented as selected or there may be an intervening period between representing the first object as selected and representing the second object as selected when neither is represented as selected.

Iterator component 354 and selection manager component 356 represent the second object as selected automatically in response to the detected do-for-each indicator. A selection indicator based on user input is not required during processing of a received do-for-indicator. Selection of each object in a plurality is automatic.

Selection manager component 356 may identify the second object based on an order of the objects in the plurality, a location on display 130 where an object is represented relative to another object such as the first object, and/or based on any number of other detectable attributes and conditions in a given execution environment.

Returning to FIG. 2, block 204 additionally includes sub-block 204d illustrating that still further in response to receiving the do-for-each indicator the method includes invoking, based on the selected second object, a second operation handler to perform a second operation. Accordingly, a system for automating operations on a plurality of objects still further in response to receiving the do-for-each indicator includes means for invoking, based on the selected second object, a second operation handler to perform a second operation. For example, as illustrated in FIG. 3, the operation agent component component 358 is configured for invoking, based on the selected second object, a second operation handler to perform a second operation, in response to receiving the do-for-each indicator.

In correspondence with determining the second object to represent as selected, iterator component 354 may call and/or otherwise instruct operation agent component 358 to invoke a second operation handler to perform an operation based on the second object. Iterator component 354 may identify the operation to operation agent component 358 and/or may instruct operation agent component 358 to identify and/or otherwise provide for identifying an operation to perform based on the selected second object has been described above with respect to the first object. The description will not be repeated here.

In an aspect, arrangements of components for performing the method illustrated in FIG. 3 may operate in a modal manner supporting a do-for-each mode. While do-for-each mode is active, an input detected by an input device may be defined as, and, thus, received and/or otherwise detected as a do-for-each indicator. When do-for-each mode is inactive the arrangement may not interpret any indicator as a do-for-each indicator.

A start mode indicator defined to activate do-for-each mode may also be the first do-for-each indicator received during the activation period. Analogously, an end mode indicator may be defined to deactivate do-for-each mode. As with the start mode indicator, an end mode indicator may also be a last do-for-each indicator received during a do-for-each activation period.

Activation and/or deactivation of do-for-each mode may be performed in response to a detected user input, a message received via a network. and/or any other detectable event(s) and/or condition(s) within an execution environment. Do for each mode may be activated for a particular portion of an application user interface, may be activated for an application, and/or may be activated by a component external to a group of applications that may all operate in do-for-each mode as a group. That is do-for-each mode may be activated and deactivated for the group.

In modal operation, receiving a do-for-each indicator includes setting a mode of operation to activate do-for-each mode. When in do-for-each mode, input router component 352 may receive an indicator that may be detected as a do-for-each indicator. Input router component 352 may be included in the second application or may operate apart from the applications it services.

When operating apart from a serviced application, input router component 352 may determine a target application or applications for a received do-for-each indicator. In response to receiving the do-for-each indicator, iterator component 354 operating apart from the target application instructs the target application to sequentially represent each object in a plurality of object as selected on a display device and to perform an operation on and/or based on objects in a plurality of objects while the objects are represented as selected sequentially in time.

While in do-for-each mode, one or more operation indicators may be detected by input router component 352. Input router component 352 may detect some of these operation indicators as do-for-each indicators based on do-for-each mode being active.

For example, a first operation indicator may be detected. In response to detecting the first operation indicator and in response to the mode being set to activate do-for-each mode, a first object is determined by selection manager component 356 as instructed by iterator component 354, to represent the first object as selected. Iterator component 354 instructs an operation agent component 358 to invoke a first operation handler to perform a first operation based on the first object. this process is repeated for each subsequent object in the plurality.

While still in do-for-each mode a second operation indicator may be detected by input router component 352. In response to detecting the second operation indicator, input router component 352, operating external to one or more applications it may service, may invoke iterator component 354 to determine a target application. The target application may be second target application different from the first target application determined in response to receiving the first operation indicator.

Alternatively, input router component 352 operating in an application may invoke iterator component 354 to determine a plurality of objects to process in response to receiving the operation/do-for-each indicator. The determined plurality of objects may be a second plurality different from the first plurality processed in response to receiving the first operation/do-for-each indicator.

Whether operating in an application or external to the target application, iterator component 354 instructs selection manager component 356 to determine a second first object in the second plurality of objects to represent as selected on a display device. Iterator component 354 further instructs an operation agent component to invoke a second first operation handler to perform a second first operation based on the selected second first object. Still further, iterator component 354 instructs selection manager component 356 to represent a second second object in the second plurality as selected on the display after representing the second first object as selected. Additionally, iterator component 354 invokes an operation agent component to invoke a second second operation handler to perform a second second operation based on the second second object.

Do-for-each mode may end when an end mode indicator is detected by input router component 352. The mode of operation is set to deactivate and/or otherwise end do-for-each mode in response to receiving the end mode indicator. An end mode indicator may be generated in response to, and/or may otherwise be detected based on any detectable condition in execution environment 102. Examples of events that may be defined to end do-for-each mode include a user input detected by an input device, an expiration of a timer, a detecting of a specified time, a change in state of the target application, and a message received via a network.

In an aspect, iterator component 354 may determine a target application. In response to receiving the do-for-each indicator, iterator component 354 operating external to the target application instructs the target application to sequentially represent each object in a plurality of object as selected on a display device and to perform and operation on and/or based on each selected object while each object is represented as selected.

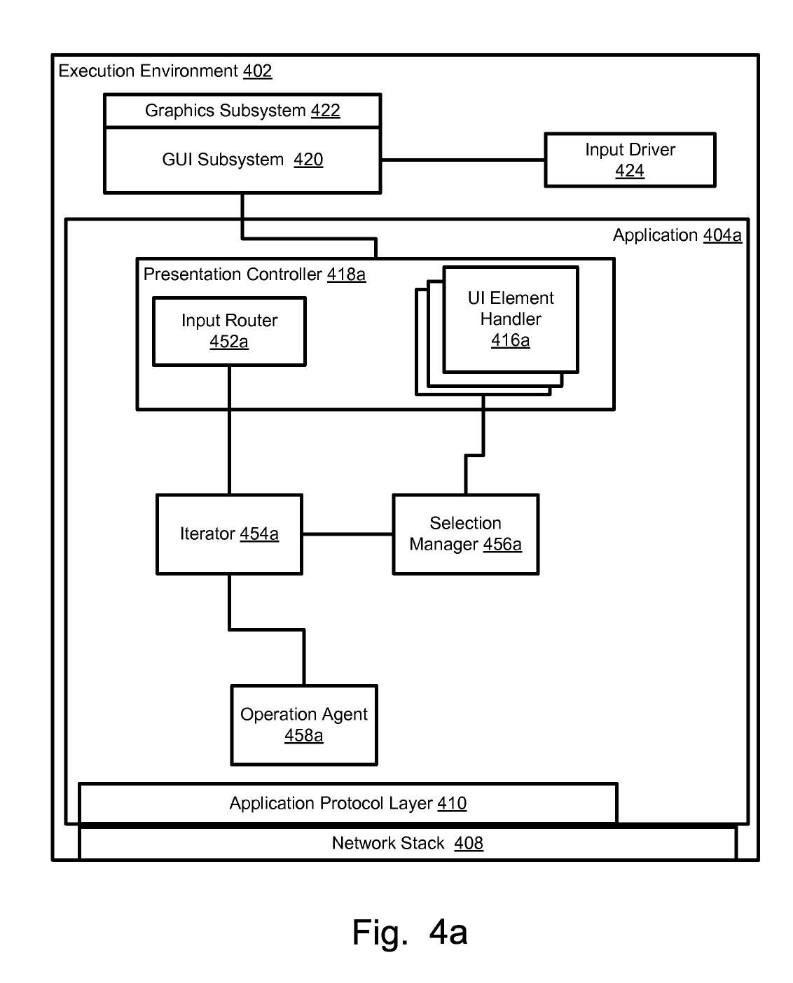

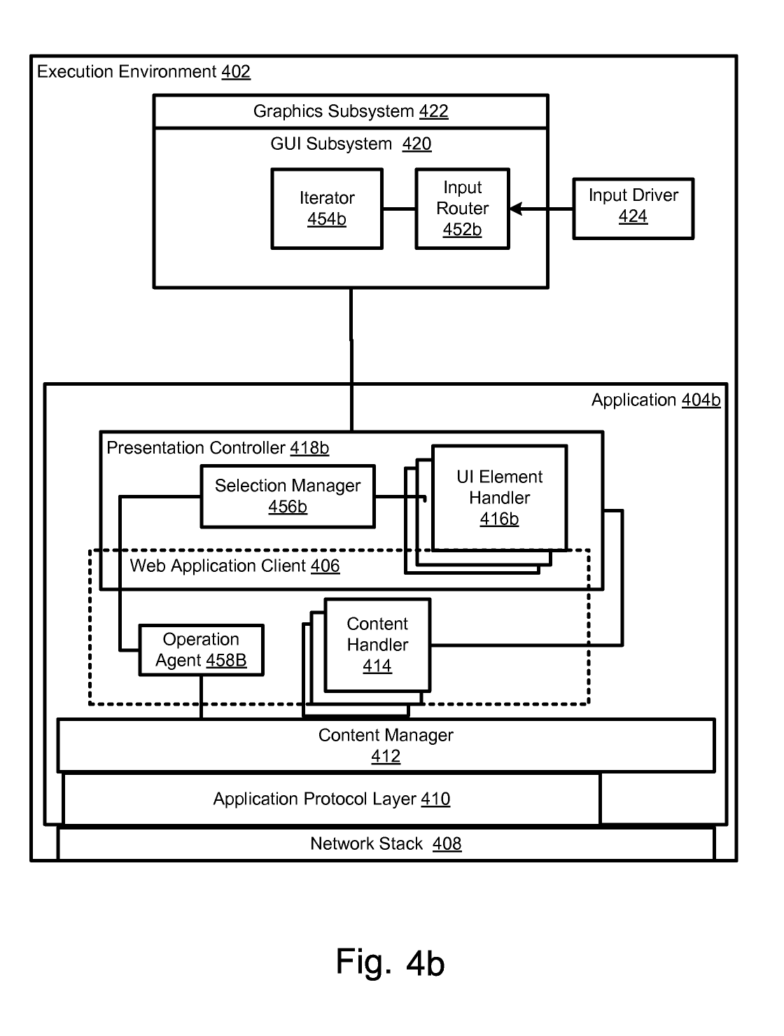

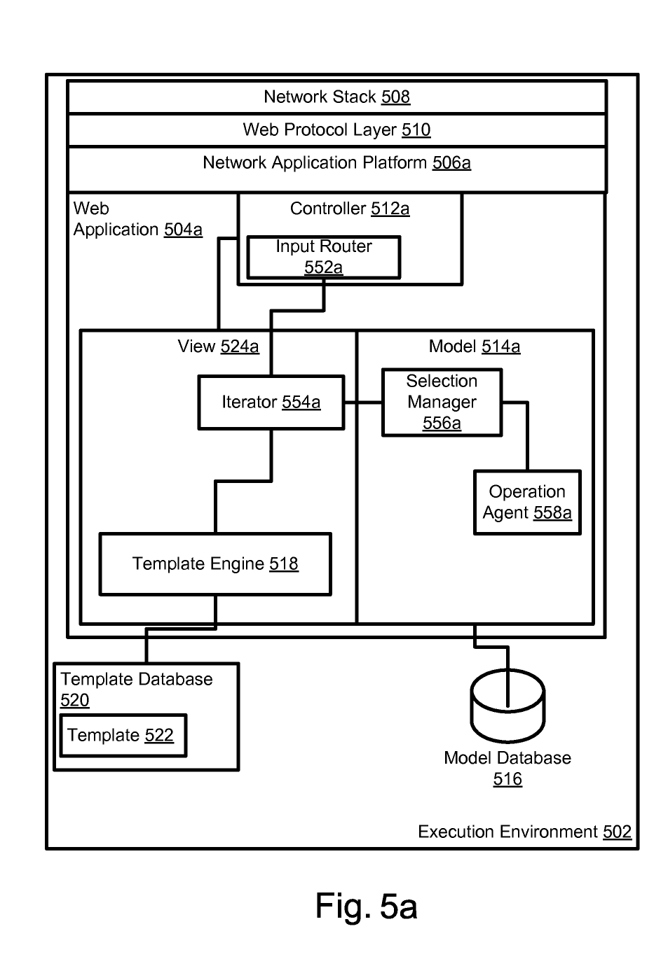

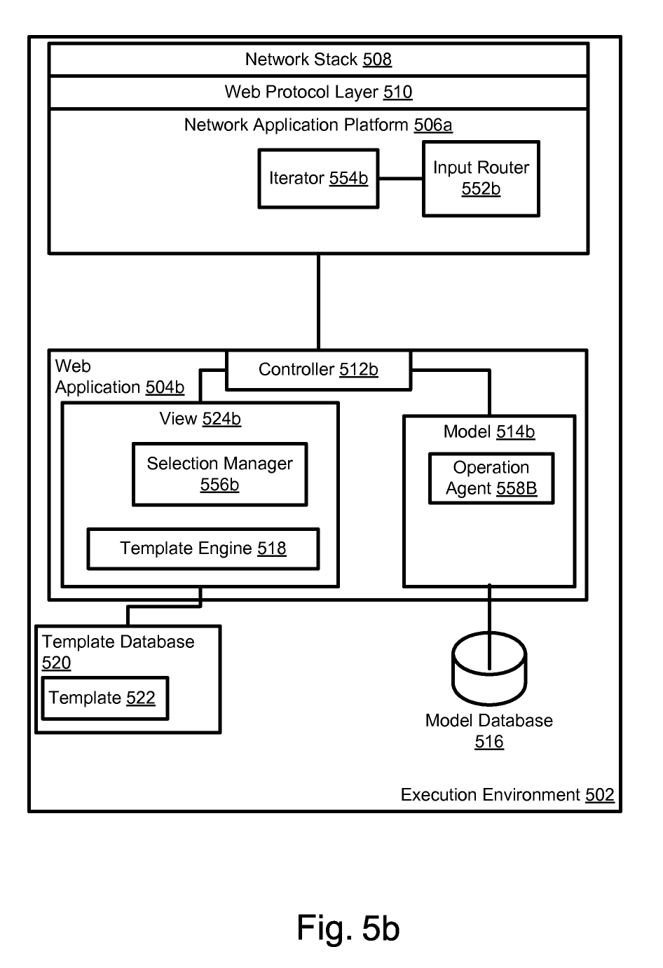

The components illustrated in FIG. 3 may be adapted for performing the method illustrated in FIG. 2 in a number of execution environments. Adaptations of the components illustrated in FIG. 3 for performing the method illustrated in FIG. 2 are described operating in exemplary execution environment 402 illustrated in FIG. 4a and also in FIG. 4b and exemplary execution environment 502 in FIG. 5a and also in FIG. 5b.

FIG. 1 illustrates key components of an exemplary device that may at least partially provide and/or otherwise be included in an exemplary execution environment, such as those illustrated in FIG. 4a, FIG. 4b, FIG. 5a, and FIG. 5b. The components illustrated in FIG. 3, FIG. 4a, FIG. 4b, FIG. 5a, and FIG. 5b may be included in or otherwise combined with the components of FIG. 1 to create a variety of arrangements of components according to the subject matter described herein

FIG. 4a illustrates target application 404a as providing at least part of an execution environment for an adaption or analog of the arrangement of components in FIG. 3. FIG. 4b illustrates target application 404b as a browser providing at least part of an execution environment for a web application client 406 received from a remote application provider. FIG. 4b also illustrates an adaption or analog of the components in FIG. 3 operating at least partially external to one or more applications serviced.

FIG. 5a illustrates a remote application provider as web application provider 504a hosting yet another adaption or analog of the arrangement of components in FIG. 3. Network application platform 506a and/or network application platform 506b may included a web server and/or a network application framework known to those skilled in the art. FIG. 5b also illustrates an adaption or analog of the components in FIG. 3 operating at least partially external to one or more applications serviced by network application platform 504b.

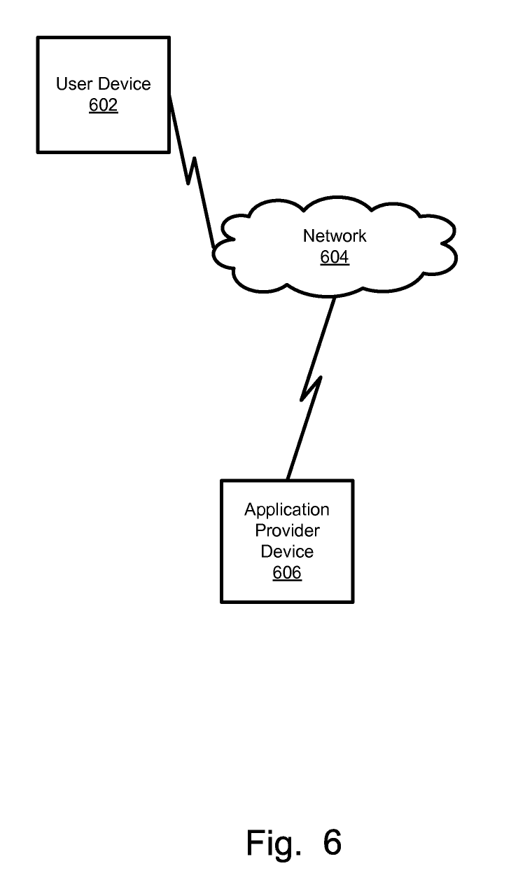

Execution environment 402 as illustrated in FIG. 4a and in FIG. 4b may include and/or otherwise be provided by a devices such as user device 602 illustrated in FIG. 6. User device 602 may communicate with one or more application providers, such as network application platform 504 operating in execution environment 502. Execution environment 502 may include and/or otherwise be provided by application provider node 606 in FIG. 6. User device 602 and application provider device 606 may each include a network interface operatively coupling each respective device to network 604.

FIG. 4a and FIG. 4b illustrate network stack component 408 configured sending and receiving messages over an internet via the network interface of user device 602. FIG. 5a and FIG. 5b illustrate network stack component 508 serving in an analogous role in application provider device 606. Network stack component 408 and network stack component 508 may support the same protocol suite, such as TCP/IP, or may communicate via a network gateway or other protocol translation device and/or service. Application 404b in FIG. 4b may interoperate with and network application platform as illustrated in FIG. 5a and in FIG. 5b via their respective network stack components, network stack component 408 and network stack component 508.

FIG. 4a, FIG. 4b, FIG. 5a, and FIG. 5b illustrate application 404a, application 404b, network application platform 504a, and network application platform 504b, respectively, configured to communicate via one or more application layer protocols. FIG. 4a and FIG. 4b illustrate application protocol layer component 410 exemplifying one or more application layer protocols. Exemplary application protocol layers include a hypertext transfer protocol (HTTP) layer and instant messaging and presence protocol, XMPP-IM layer. FIG. 5a and FIG. 5b illustrate a compatible application protocol layer component as web protocol layer component 510. Matching protocols enabling user device 602 to communicate with application provider device 606 via network 604 in FIG. 6 are not required if communication is via a protocol translator.

In FIG. 4b application 404b may receive web application client 406 in one more messages sent from web application 504a via network application platform 506a and/or sent from web application 504b via network application platform 506b via the network stack components, network interfaces, and optionally via an application protocol layer component in each respective execution environment. Application 404b includes content manager component 412 as FIG. 4b illustrates. Content manager component 412 is illustrated configured to interoperate with one or more of the application layer components and/or network stack component 408 to receive the message or messages including some or all of web application client 406.

Web application client 406 may include a web page for presenting a user interface for web application 504a and/or web application 504b. The web page may include and/or reference data represented in one or more formats including hypertext markup language (HTML) and/or markup language, ECMAScript or other scripting language, byte code, image data, audio data, and/or machine code.

The data received by content manager component 412 may be received in response to a request sent in a message to web application and/or may be received asynchronously in a message with no corresponding request.

In an example, in response to a request received from application 404b controller component 512a, 512b in FIG. 5a and in FIG. 5b, respectively, may invoke model subsystem 514a, 514b to perform request specific processing. Model subsystem 515a, 516b may include any number of request processors for dynamically generating data and/or retrieving data from model database 516 based on the request. Controller component 512a, 512b may further invoke template engine 518 to identify one or more templates 522 and/or static data elements for generating a user interface for representing a response to the received request.

FIG. 5a and FIG. 5b illustrate template database 520 including an exemplary template 522. FIG. 5a and FIG. 5b illustrate template engine 518 as a component of view subsystem 524a and view subsystem 524b, respectively, configured for returning responses to processed requests in a presentation format suitable for a client, such as application 404b. View subsystem 524a, 524b may provide the presentation data to controller component 512a, 512b to send to application 404b in response to the request received from application 404b. Web application client 406 may be sent to application 404b in the via network application platform 504 interoperating with network stack component 508 and/or application layer component 510.

While the example describes sending web application client 406 in response to a request, web application 506a, 506b additionally or alternatively may send some or all of web application client 406 to application 404b via one or more asynchronous messages. An asynchronous message may be sent in response to a change detected by web application 506a, 506b. A publish-subscribe protocol such as the presence protocol specified by XMPP-IM is an exemplary protocol for sending messages asynchronously in response to a detected change.

The one or more messages including information representing web application client 406 may be received by content manager component 412 via one or more of the application protocol layer components 410 and/or network stack component 408 as described above. FIG. 4b illustrates application 404b includes one or more content handler components 414 to process received data according to its data type, typically identified by a MIME-type identifier. Exemplary content handler components include a text/html content handler for processing HTML documents; an application/xmpp-xml content handler for processing XMPP streams including presence tuples, instant messages, publish-subscribe data, and request-reply style messages as defined by various XMPP specifications; one or more video content handler components processing video streams of various types; and still image data content handler components for processing various images types. Content handler components 414 process received data and may provide a representation of the processed data to one or more user interface element handler components 416b.

User interface element handler components 416a are illustrated in presentation controller component 418a in FIG. 4a and user interface element handler components 416b are illustrated operating in presentation controller component 418b in FIG. 4b, referred to generically as graphic handler(s) 416 and presentation controller component(s) 418. Presentation controller component 418 may manage the visual components of its including application as well as receive and route detected user and other input to components and extensions of its including application. A user interface element handler components 416b in various aspects may be adapted to operate at least partially in a content handler 414 such as the text/html content handler and/or a script content handler. Additionally or alternatively a user interface element handler component 416 may operate in an extension of its including application, such as a plug-in providing a virtual machine for script and/or byte code.

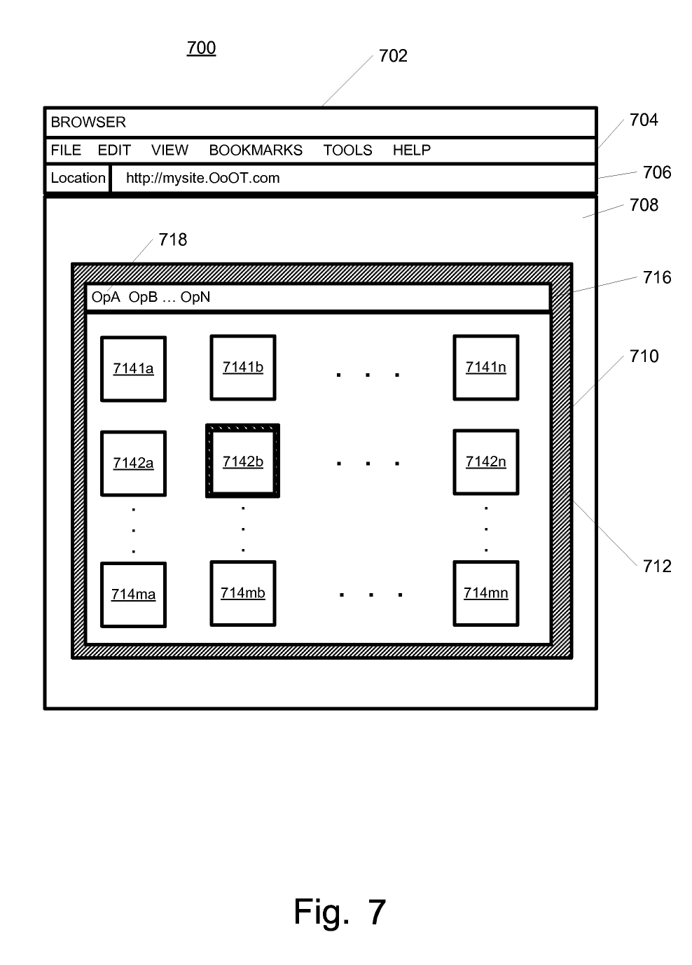

FIG. 7 illustrates an exemplary user interface 700 of application 404b. User interface 700 illustrates a number of user interface elements typically found in browsers including title bar 702, menu bar 704 including user interface elements visually representing various menus, location bar 706 including a text user interface element representing a uniform resource locator (URL) identifying a location or source of one or user interface elements presented in a presentation space of page/tab pane 708. The various user interface elements illustrated in page/tab pane 708 in FIG. 7 are visual representations based on representation information from a resource provider such as web application 506a, 506b in FIG. 5a, FIG. 5b operating in execution environment 502 and/or in application 404b as illustrated by web application client 406.

Task pane, in one aspect illustrates a user interface of web application client 406 and thus a user interface of web application 506a, 506b. In another aspect, (not shown) task pane 710 may be presented as a user interface of application 404a not requiring a browser presentation space. For example, application 404a may be an image viewer and/or photo managing application, a video player and/or video library, a word processor, or other application.

The various user interface elements of application 404b and application 404a described above are presented by one or more user interface element handler components 416. In an aspect illustrated in FIG. 4a and in FIG. 4b, a user interface element handler component 416 of either application 404a, 404b is configured to send representation information representing a program entity, such as title bar 702 or task pane 710 illustrated in FIG. 7 to GUI subsystem 420. GUI subsystem 420 may instruct graphics subsystem 422 to draw a user interface element in a region of a presentation space based on representation information received from a corresponding user interface element handler component 416.

Returning to FIG. 7, task pane 710 includes an object window 712 including visual representations of various objects of web application 506a, 506b and/or web application client 406, or of application 404a in another aspect described above. The objects are illustrated as object icons 714. Object icon 7142b is a first visual representation of a first object. The first object is represented as selected as indicated by a visually distinguishing attribute of the first visual representation. In FIG. 7, object icon 7142b is presented with a thicker border than other object icons 714. Those skilled in the art will recognized that there are numerous visual attributes usable for representing a visual representations as selected.

FIG. 7 also illustrates operation bar 716. A user may move a mouse to move a pointer presented on display 130 over an operation identified in operation bar 716. The user may provide an input detected by the mouse. The detected input is received by GUI subsystem 420 via input driver component 424 as an operation indicator based on the association of the shared location of pointer and the operation identifier on display 130.

FIG. 4a and FIG. 4b, respectively, illustrate input router component 452a and input router component 452b as adaptations of and/or analogs of input router component 352 in FIG. 3. FIG. 4a illustrates input router component 452a operating in application 404a. FIG. 4b illustrates input router component 452b operating external to application 404b and other applications it may serve in execution environment 402. As illustrated in FIG. 4a and in FIG. 4b, input router component 452a and input router component 452b are each configured for receiving, based on a user input detected by an input device, a do-for-each indicator by a target application configured to process a plurality of objects.

In the arrangement of components illustrated in FIG. 4a, input router component 452a is configured to receive and/or otherwise detect a do-for each indicator based on communication with GUI subsystem 420. GUI subsystem 420 receives input information from input driver component 424 in response to a detected user input. In FIG. 4b, input router component 452b receives and/or otherwise detects a do-for-each indication based on communication with input driver component 426. Input driver component 426 is operatively coupled to input device adapter 110. Input device adapter 110 receives input information from input device 128 when input device 128 detects an input from a user. Input driver component 424 generates an input indicator based on the input and sends the input indicator to input router component 452a, 452b directly or indirectly. An input indicator may identify the source of the corresponding detected input, such as a keyboard and one or more key identifiers.

Input router component 452b may recognized one or more input indicators as system defined input indicators that may be processed according to their definition(s) by GUI subsystem 420 and its included and partner components. Input router component 452a may recognize one or more inputs as application defined to be processed according to their application definition(s). Input router component 452b may pass an application defined indicator for routing to an application for processing without interpreting the indicator as requiring additional processing by GUI subsystem 420. Some input indicators may be system defined and further defined by receiving applications.

One or more particular indicators may be defined as a do-for-each indicator or do-for-each indicators by various adaptations of the arrangement of components in FIG. 3, such as arrangements of components in FIG. 4a and in FIG. 4b. In FIG. 4a and in FIG. 4b. In response to detecting a do-for-each indicator input router component 452a and input router component 452b may interoperate with iterator component 454a and iterator component 454b, respectively, to further process the do-for-each indicator as configured by the particular arrangement of components.

For example, FIG. 7 shows object 7142b as a selected object. An input, such as mouse click may be detected while a pointer user interface element is presented over an operation indicator, such as OpA 718. The mouse click may be detected while do-for-each mode is active identifying the operation indicator as a do-for-each indicator.

In a further, aspect, a mouse click may be detected while the pointer user interface element is over object 7142b. Object 7142b may be presented as selected prior to and during detection of the mouse click or may be presented as unselected. A mouse click detected that corresponds to a presented object 714 may be defined to be and/or produce a do-for-each indicator either when detected by itself and/or in correspondence with another input and/or attribute detectable in execution environment 402. Further, the mouse click on object 7142b may be received while do-for-each mode is active, thus defining the mouse click as a do-for-each indicator in the mode in which it is detected.

FIG. 5a and FIG. 5b, respectively, illustrate input router component 552a and input router component 552b as adaptations of and/or analogs of input router component 352 in FIG. 3. FIG. 5a illustrates input router component 552a operating in web application 504a in execution environment 502. FIG. 5b illustrates input router component 552b operating network application platform 506b external to web application 504b. As illustrated in FIG. 5a and in FIG. 5b, input router component 552a and input router component 552b are each configured for receiving, based on a user input detected by an input device, a do-for-each indicator by a target application configured to process a plurality of objects.

In FIG. 5a, input router component 552a is configured to receive a do-for-each indicator via network application platform 506a. Network application platform 506a provides the input indication to input router component 552a in a message from a client device, such as user device 602. In FIG. 5a, input router component 552a is illustrated as a component of controller component 512a, and thus may receive information based on receive messages via network application platform 506, web protocol layer component 510, and/or network stack component 508 as described above.

In FIG. 5b, input router component 552b is a component of network application platform 506b. As such, input router component 552b may to receive an input indicator via web protocol layer component 510 and or network stack component 508. Input router component 552b may receive and/or otherwise detect the input indication in a message from a client device. Input router component 552b may receive the message including and/or otherwise identifying the input indicator before a target application for the message and input indicator have been determined and/or may process the input indicator before providing information based on the message to a target application.

Various values and formats of information based on input detected by input device 128 may be detected as input indicators based on information received in messages by input router component 552a, 552b. Examples described above include an operation indicator associated with OpA 718, keyboard inputs, and inputs corresponding to an object 714 whether selected or unselected. One or more input indicators detected by input router component 552a, 552b may be detected as a do-for-each indicator and/or a combination do-for-each and other indicator, such as an operation indicator and/or a selection indicator.

As described with respect to various aspects of FIG. 4a and FIG. 4b, start mode and end mode indicators may be supported and received in messages from remote client devices. Input router component 552a, 552b may detect indicators for activating and/or deactivating do-for-each mode in messages from user device 602.

Input router component 552a, 552b may receive raw unprocessed input information and be configured to detect a do-for-each indicator based on the information. Alternatively or additionally, application 404b and/or web application client 406 may detect a do-for-each indicator from received input information, and send a message including information defined to identify a do-for-each indicator based on a configuration of application 404b and/or web application client 406, and input router component 552a, 552b. That is, either or both client and server may detect an input indicator as described in this document. The form an input indicator takes may vary between client and server depending on the execution environment and configuration of a particular input router component.

For example a user input detected by user device 602 may be processed by components in execution environment 402 to send a message to application provider device 606. Information generated in response to a mouse click on object 7142b may be provided to application 404b and/or web application client 406 for processing. The processing may include a request to content manager component 412 to send a message to web application 504a, 504b via network 604 as described.

In an example, FIG. 7 shows object 7142b as a selected object. An input, such as a touch may be detected in a region of display 130 of user device 602 including user interface element for object 7142b. The tactile input may be defined and, thus, received as a selection indicator. Input router component 552a, 552b may receive and/or otherwise detect the selection indicator based on a message received by application provider device 606 from application 404b and/or web application client 406 sent in response to the detected input. The message may include information based on the detected input which input router component 552a, 552b is configured to detect as a do-for-each indicator. Input router component 552a, 552b may detect the information as a do-for-each indicator while do-for-each mode is active if input router component 552a, 552b is configured to support modal operation.

Alternatively or additionally, the touch may be detected in correspondence with a user press of a function key that may be sent to application 404b and/or web application client 406. Application 404b and/or web application client 406 may send a message to application provider device 606 including information routed to input router component 552a, 552b. Input router component 552a, 552b may identify the detected combination of inputs as a do-for-each indicator. In an aspect, web application client 406 may detect the combination of detected inputs and send a message identifying an input indicator hiding input details from web application 506a and/or network application platform 504b.

As with execution environment 402, in a further, aspect, a touch, mouse click, or other input may be detected corresponding to an operation control, such as OpA 718. An object, such as object 7142b, may be presented as selected prior to and during detection of the detected input corresponding to the operation indicator of OpA 718 or may be presented as unselected. An input corresponding to an operation control may be defined to be and/or produce a do-for-each indicator based on information sent in a message to application provider device 606 in response to the detected input. Further, the detected input corresponding to OpA 718 may be received while do-for-each mode is active in network application platform, thus defining the input information received by input router component 552a, 552b resulting from the detected user input as a do-for-each indicator in the context in which it is detected.

FIG. 4a and FIG. 4b, respectively, illustrate selection manager component 456a and selection manager component 456b operating in execution environment 402 as adaptations of and/or analogs of selection manager component 356 in FIG. 3. As illustrated in FIG. 4a and in FIG. 4b, selection manager component 456a and selection manager component 456b are each configured for determining a first object in the plurality represented as selected on a display device, in response to receiving the do-for-each indicator.

As described above and illustrated further in FIG. 4a and FIG. 4b iterator component 454a and iterator component 454b are operatively coupled to input router component 452a and input router component 452b, respectively. Either coupling may be direct or indirect through one or more other components. Iterator component 454a, 454b may receive the detected do-for-each indicator and/or information identified by, based on, and/or otherwise associated with the detected do-for-each indicator via interoperation with input router component 452a, 452b. The interoperation and information exchange is performed in response to receiving and/or otherwise detecting the do-for-each indicator by input router component 452a, 452b. Iterator component 454a, 454b may instruct, direct, and/or otherwise provide for other components in execution environment 402 to perform portions of the method illustrated in FIG. 2 illustrated by sub-blocks of block 204.

In FIG. 4b, iterator component 454b is configured for identifying a target application for the do-for-each indicator. An input indicator detected by input router component 452b may be directed to a particular application operating in execution environment 402. Input router component 452b may provide information to iterator component 454b to determine the target application.

In an aspect, GUI subsystem 420 is configured to track a window, dialog box or other user interface element presented on display 130 that currently has input focus. Iterator component 454b may determine a user interface element in user interface 700 has input focus when an input from a keyboard is received. Alternatively or additionally, iterator component 454b operating in GUI subsystem 420 may determine and/or otherwise identify the target application based on a configured association between an input detected by a pointing device and a position of a mouse pointer on display 130. For example, a mouse click and/or other input is detected while a pointer user interface element is presented over a visual component of task pane 710. Task pane 710 is a visual component of user interface 700 of browser 404.

Iterator component 454b operating in GUI subsystem 420 may track positions of various user interface elements including the mouse pointer and visual components of user interface 700. Input router component 452b may interoperate with iterator component 454b providing position information. Based on the locations of the pointer user interface element, user interface 700, and the source input device (a mouse), iterator component may associate the input with browser 404.

Alternatively or additionally, GUI subsystem 420 may define a particular user interface element as having input focus. As those skilled in the art will know, a user interface element with input focus typically is the target of keyboard input. When input focus changes to another user interface element, keyboard input is directed to the user interface element with input focus. Thus iterator component 454b may determine and/or otherwise identify a target application based on a state variable such as a focus setting and based on the detecting input device. A focus setting may apply to all input devices or a portion of input devices in an execution environment. Different input devices may have separate focus settings associated input focus for different devices with different applications and/or user interface elements.

Alternatively or additionally, an input device and/or a particular detected input may be associated with a particular application, a particular region of a display, or a particular user interface element regardless of pointer position or input focus. For example, a region of a display may be touch sensitive while other regions of the display are not. The region may be associated with a focus state, a pointer state, or may be bound to a particular application.

In another example, a pointing input, such as a mouse click, is detected corresponding to a presentation location of user interface element, OpA 718. Identifying an operation to be performed on a selected object, object 7142b. Iterator component 454b may identify browser 404 as the target application.

In an aspect, iterator component 454b may determine a user interface element handler component 416b corresponding the visual representation of OpA 718 or object 7142b and, thus, identify web application client 406 as the target application via identifying a user interface element handler component of web application client 406. Additionally or alternatively, by identifying browser 404 and/or web application client 406, iterator component 454b indirectly may determine and/or otherwise identify web application 506a, 506b as the target application depending on the configuration of browser 404, web application client 406, and/or web application 506a, 506b.

In response to receiving the do-for-each indicator, iterator component 454a, 454b invokes and/or otherwise instructs selection manager component 456a, 456b to determine a first object in the plurality represented on display 130 as selected. An object may be visually represented as selected. For example, object 7142b is represented as selected based on the thickness of a border of object 7142b.

Selection manager component 456a, 456b may determine a first selected object based on identifying object 7142b as selected when and/or within a specified time period of detecting the do-for-each indicator. In an aspect, a detected touch on display 130 in a region including object 7141a, which is not presented as selected, may be defined and detected by input router component 452a, 452b as a do-for-each indicator. Selection manager component 456a, 456b may determine object 7141a to be the first object and present and/or provide for presenting object 7141a as selected on display 130.

The touch may be detected in correspondence with another input detectable as a do-for-each indicator and/or may be detected in an aspect supporting do-for-each modal operation. The touch of object 7141a, in either case described in this paragraph, is both a selection indicator and a do-for-each indicator.

FIG. 5a and FIG. 5b, respectively, illustrate selection manager component 556a and selection manager component 556b operating in execution environment 502 as adaptations of and/or analogs of selection manager component 352 in FIG. 3. As illustrated in FIG. 5, selection manager component 556 are each configured for determining a first object in the plurality represented as selected on a display device, in response to receiving the do-for-each indicator.

As illustrated in FIG. 5a and in FIG. 5b, iterator component 554a, 554b may be operatively coupled to input router component 552. The coupling may be direct or indirect through one or more other components. Iterator component 554a, 554b may receive the detected do-for-each indicator and/or information identified by, based on, and/or otherwise associated with the detected do-for-each indicator via interoperation with input router component 552. The interoperation and information exchange is performed in response to receiving and/or otherwise detecting the do-for-each indicator by input router component 552.

In FIG. 5b, iterator component 554b is configured for identifying a target application for the do-for-each indicator. An input indicator detected by input router component 552b may be directed to a particular application operating in execution environment 502. Input router component 552b may provide information to iterator 554b to determine the target application.

A do-for-each indicator detected by input router component 552b may be directed to a particular application operating in execution environment 502. Input router component 552b may provide information to iterator component 554b to determine the target application, such as a portion of a universal resource locator (URL) included in the message identifying the do-for-each indicator.

In an aspect, network application platform 506a, 506b is configured to maintain records identifying an application configured to use network application platform 506a, 506b and a URL or a portion of a URL such as a path portion to associate received messages with applications serviced by network application platform, such as web application 504a, 504b. Each application may be associated with one or more identifiers based on a URL. Messages received by network application platform, such as HTTP messages, may include some or all of a URL. Iterator component 554b in FIG. 5b may locate a record based on the URL in a received message to identify the target application identified in the received message and in the located record.

Alternatively or additionally, a target application may be identified by iterator component 554b operating in network application platform 504 based on a protocol in which a message from a client is received. For example, a presence service may be configured as the target application for all messages conforming to a particular presence protocol. Iterator component may additionally or alternatively determine a target application based on a tuple identifier, a port number associated with sending and/or receiving the received message, information configured between a particular client and network application platform to identify a target application for messages from the particular client, an operation indicator, and/or a user and/or group identifier too name a few examples.

In an aspect, a message from application 404b and/or web client application 406 may identify a particular user interface element presented in page/tab pane 708 of user interface 700 of browser 404 and web application client 406. Iterator component 554b may identify a target application based on information the particular user interface element corresponding to a user detected input detected by user device 602.

In an example, a touch input may be detect corresponding to an object 714, such as object 7142b. A message including a URL identifier of web application and information based on the detected touch may be received by input router component 552b. Iterator component 554b may identify web application 504b as the target application. In an aspect, iterator component 554b may determine a component of view subsystem 524b and/or model subsystem 514b corresponding the object visually represented by the user interface element object 7142b, and thus identify web application 504b as the target application via identifying a corresponding component of web application 504b.

In response to receiving the do-for-each indicator, iterator component 554a, 554b invokes and/or otherwise instructs selection manager component 556a, 556b to determine a first object in the plurality represented on display 130 as selected. An object may be visually represented as selected, such as object 7142b.

Selection manager component 556a, 556b may determine a first selected object based identifying object 7142b as selected when and/or within a specified time period of detecting the do-for-each indicator. In an aspect, a detected touch on display 130 in a region including object 7141a, which is not presented as selected, may be defined and detected by input router component 552a, 552b as a do-for-each indicator. Selection manager component 556a, 556b may determine object 7141a to the first object and present and/or provide for presenting object 7141a as selected on display 130.

The touch may be detected in correspondence with another input detectable as a do-for-each indicator and/or may be detected by arrangement of components supporting do-for-each modal operation. The touch of object 7141a, in this example described, is both a selection indicator and a do-for-each indicator.

FIG. 4a and FIG. 4b, respectively, illustrate operation agent component 458a and operation agent component 458b operating in execution environment 402 as adaptations of and/or analogs of operation agent component 358 in FIG. 3. As illustrated in FIG. 4a and in FIG. 4b, operation agent component 458a and operation agent component 458b are each configured for invoking, based on the selected first object, a first operation handler to perform a first operation, in response to receiving the do-for-each indicator.

In correspondence with determining the first object, iterator component 454a, 454b may identify and/or instruct operation agent component 458a, 458b to identify an operation to perform based on the selected first object call. As described above, the operation may be identified by the do-for-each indicator and/or by information received along with the do-for-each indicator. In FIG. 7, an operation user interface element, such as OpA 718 may be selected by a user. The user input may be detected prior to the touch of object 7141a described in an example above. The selection of OpA 718 prior to the detected touch of object 7141a may associate an operation identified by OpA 718 with the do-for-each indicator received in response to the touch of object 7141a.

In an aspect one or more operations may be selected from operation bar 716 prior to detecting a touch of object 7141a. One or more of the operations selected may identify an operation handler for one or more of the objects 714 sequentially presented as selected including the first object.

In a variation, iterator component 454a, 454b and/or operation agent component 458a, 458b may receive information identifying a number of operations. For example, five operations may be selected by a user. Iterator component 454a, 454b and/or operation agent component 458a, 458b may determine that each operation corresponds to one of five objects to be presented sequentially as selected starting with the determined first object. The objects may be ordered when the operation indicators are received, and/or ordered by iterator component 454a, 454b and/or operation agent component 458a, 458b.

Alternatively or additionally, when an object is already selected, such as object 7142b, a selection of OpA 718 may be detected as a do-for-each indicator and an operation indicator in do-for-each mode or as defined in a non-modal arrangement.

Based on a selected object, such as the first selected object, an operation handler is identified as described above and invoked by operation agent component 458a, 458b to perform an operation. Invocation of an operation handler may be direct and/or indirect via one or more other components in execution environment 402. Invocation of an operation handler may include calling a function or method of an object; sending a message via a network; sending a message via an inter-process communication mechanism such as pipe, semaphore, shared data area, and/or queue; and/or receiving a request such as poll and responding to invoke an operation handler.

FIG. 5a and FIG. 5b, respectively, illustrate operation agent component 558a and operation agent component 558b operating in execution environment 502 as adaptations of and/or analogs of operation agent component 358 in FIG. 3. As illustrated in FIG. 5a and in FIG. 5b, operation agent component 558a and operation agent component 558b are each configured for invoking, based on the selected first object, a first operation handler to perform a first operation, in response to receiving the do-for-each indicator.

In correspondence with determining the first object, iterator component 554a, 554b may identify and/or instruct operation agent component 558a, 558b to identify an operation to perform based on the selected first object. FIG. 5a and FIG. 5b each illustrate iterator component 554a, 554b instructing and/or otherwise interoperating with operation agent component 558a, 558b through selection manager component 556a, 556b. As described the operation may be identified by the do-for-each indicator and/or by information received along with the do-for-each indicator.

Iterator component 554a, 554b and/or operation agent component 558a, 558b may identify operations in a sequential manner; identifying a first operation for performing based on an attribute of the selected first object, identifying a second operation for performing based on a selected second object, and so on for each other object in the plurality of objects. For example, a user of web application client 406 operating in user device 602 may be identified to web application 504a, 504b through one or more messages exchanged between application 404b and web application 504a, 504b via network 604. The user may be assigned a role identifying access privileges associated with each object 714. Web application 504a, 504b may be human resources application and each object 714 may represent an employee or a group of employees. The user role may vary according to each selected object.

The user may be a direct report of an employee represented by object 7141a, an indirect report of employee 7141b, a member of the same department as employee 7143c (not shown), a manager of employee 7142a, object 7142b may represent the user, and other objects 714 may represent contractors, employees of partner companies, and the like. As each object is presented as selected, the operation handler invoked may be based on the user's role with respect to the object.

Based on a selected object, such as the first selected object, an operation handler is identified as described above and invoked by operation agent component 558a, 558b to perform an operation. Invocation of an operation handler may be direct and/or indirect via one or more other components in execution environment 502. Invocation of an operation handler may include calling a function or method of an object; sending a message via a network; sending a message via an inter-process communication mechanism such as pipe, semaphore, shared data area, and/or queue; and/or receiving a request such as poll and responding to invoke an operation handler.

In an aspect, the plurality of objects may be determined based on a filter such as the identity of the user. Only direct reports will be represented as selected.

FIG. 4a and FIG. 4b, respectively, illustrate selection manager component 456a and selection manager component 456b operating in execution environment 402 as adaptations of and/or analogs of selection manager component 356 in FIG. 3. As illustrated in FIG. 4a and in FIG. 4b, selection manager component 456a and selection manager component 456b are each configured for representing a second object in the plurality as selected on the display device after the first object is represented as selected, in response to receiving the do-for-each indicator.

After the first object is represented as selected on display 130, iterator component 454a, 454b may invoke and/or otherwise instruct selection manager component 456a, 456b again to represent a second object in the plurality as selected on display 130. There may be period of overlap when both the first and second object are represented as selected or there may be an intervening period between representing the first object as selected and representing the second object as selected when neither is represented as selected.

Iterator component 454a, 454b and/or selection manager component 456a, 456b represent the second object as selected automatically in response to the detected do-for-each indicator. A selection indicator based on user input is not required during processing of a received do-for-indicator. Selection of each object in a plurality is automatic.

As described above, FIG. 5a and FIG. 5b illustrate selection manager component 556a and selection manager component 556b operating in execution environment 502 as adaptations of and/or analogs of selection manager component 356 in FIG. 3. As illustrated in FIG. 5a and in FIG. 5b, selection manager component 556a and selection manager component 556b are each configured for representing a second object in the plurality as selected on the display device after the first object is represented as selected, in response to receiving the do-for-each indicator.

After the first object is represented as selected on display 130, iterator component 554a, 554b may invoke and/or otherwise instruct selection manager component 556a, 556b again to represent a second object in the plurality as selected on display 130. Alternatively, iterator component 554a 554b may invoke or otherwise instruct selection manger 556a, 556b to determine and present the first object and the second object and subsequent objects, if any, as selected in a sequential manager. Iterator component 554a, 554b and/or selection manager component 556a, 556b represent the second object as selected automatically in response to the detected do-for-each indicator. A selection indicator based on user input is not required during processing of a received do-for-indicator. Selection of each object in a plurality is automatic.

FIG. 4a and FIG. 4b, respectively, illustrate operation agent component 458a and operation agent component 458b operating in execution environment 402 as adaptations of and/or analogs of operation agent component 358 in FIG. 3. As illustrated in FIG. 4a and in FIG. 4b, operation agent component 458a and operation agent component 458b are each configured for invoking, based on the selected second object, a second operation handler to perform a second operation, in response to receiving the do-for-each indicator.

In correspondence with determining the second object to represent as selected, iterator component 454a, 454b may call and/or otherwise instruct operation agent component 458a, 458b to invoke a second operation handler. This may include identifying a second operation different than the first operation. Identifying objects to presented as selected as well as identifying and performing operations based on objects presented as selected is described above and will not be repeated here.

As described above, FIG. 5a and FIG. 5b, respectively, illustrate operation agent component 558a and operation agent component 558b operating in execution environment 502 as adaptations of and/or analogs of operation agent component 358 in FIG. 3. As illustrated in FIG. 5a and in FIG. 5b, operation agent component 558a and operation agent component 558b are each configured for invoking, based on the selected second object, a second operation handler to perform a second operation, in response to receiving the do-for-each indicator.

In correspondence with determining the second object to represent as selected, iterator component 554a, 554b may call and/or otherwise instruct operation agent component 558a, 558b to invoke a second operation handler. This may include identifying a second operation different than the first operation. Identifying objects to presented as selected as well as identifying and performing operations based on objects presented as selected is described above and will not be repeated here.

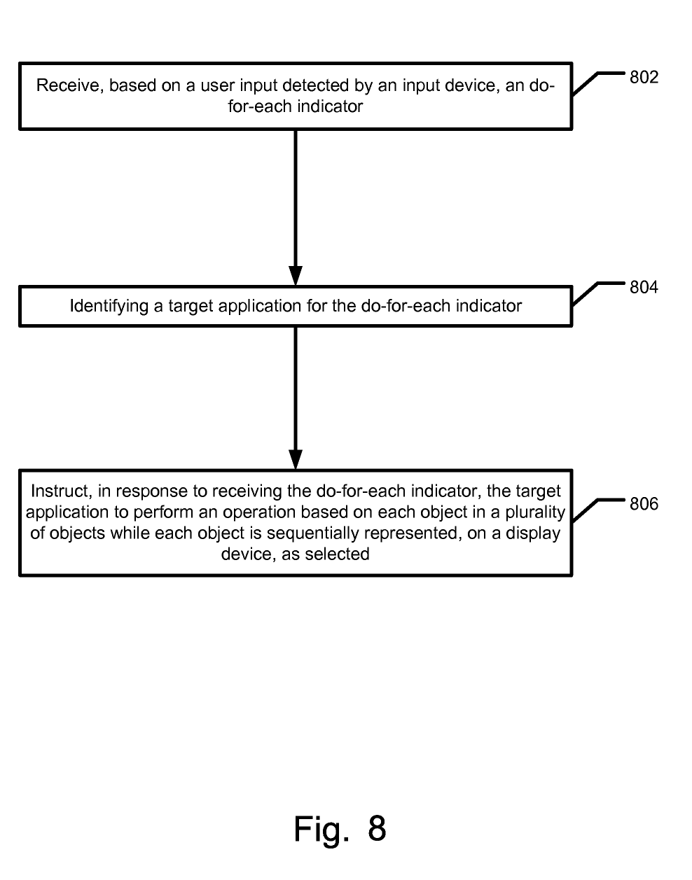

FIG. 8 is a flow diagram illustrating a method for automating operations on a plurality of objects according to an exemplary aspect of the subject matter described herein. FIG. 3 is a block diagram illustrating input router component 352 and iterator component 354 as an arrangement of components for automating operations on a plurality of objects according to another exemplary aspect of the subject matter described herein.

A system for automating operations on a plurality of objects includes an execution environment, such as execution environment 102, including an instruction processing machine, such as processor 104 configured to process an instruction included in at least one of an input router component and an iterator component. Input router component 352 and iterator component 354 illustrated in FIG. 3 may be adapted for performing the method illustrated in FIG. 8 in a number of execution environments. Descriptions of adaptations and/or analogs for input router component 352 and iterator component 354 are provided above with respect to arrangements of components illustrated in FIG. 1, FIG. 4a, FIG. 4b, FIG. 5a, and FIG. 5b.

With reference to FIG. 8, block 802 illustrates the method includes receiving, based on a user input detected by an input device, a do-for-each indicator. Accordingly, a system for automating operations on a plurality of objects includes means for receiving, based on a user input detected by an input device, a do-for-each indicator. For example, as illustrated in FIG. 3, a input router component 352 is configured for receiving, based on a user input detected by an input device, a do-for-each indicator.

With respect to block 802 and the method illustrated in FIG. 8, input router component 352 operates in execution environment external to one or more applications 122. FIG. 4b and FIG. 5b illustrate adaptations and/or analogs of input router component 352 operating external to one or more applications serviced in performing the method illustrated in FIG. 8 including block 802 as described with respect to FIG. 4b and FIG. 5b.

Returning to FIG. 8, block 804 illustrates the method further includes identifying a target application for the do-for-each indicator. Accordingly, a system for automating operations on a plurality of objects includes means for identifying a target application for the do-for-each indicator. For example, as illustrated in FIG. 3, iterator component 354 is configured for identifying a target application for the do-for-each indicator.

A user input detected by input device 128 may be directed to a particular application operating in execution environment 102. FIG. 3 illustrates iterator component 354 configured to determine the target application with respect to block 804. The target application may be one of a number of applications 122 operating in execution environment 102.

Returning to FIG. 8, block 806 illustrates the method yet further includes instructing, in response to receiving the do-for-each indicator, the target application to perform an operation on each object in a plurality of objects while each object is sequentially represented on a display device as selected. Accordingly, a system for automating operations on a plurality of objects includes means for instructing, in response to receiving the do-for-each indicator, the target application to perform an operation on each object in a plurality of objects while each object is sequentially represented on a display device as selected. For example, as illustrated in FIG. 3, a iterator component 354 is configured for instructing, in response to receiving the do-for-each indicator, the target application to perform an operation on each object in a plurality of objects while each object is sequentially represented on a display device as selected.

Operation of iterator component 354 in execution environment 102 is described above. With respect to block 806 and the method illustrated in FIG. 8, iterator component 354 operates in execution environment external to one or more applications 122. FIG. 4b and FIG. 5b illustrate adaptations and/or analogs of iterator component 354 operating external to one or more applications serviced and their operation in performing block 806 is described above.

It is noted that the methods described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include in one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

I claim:

1. A method for automating operations on a plurality of objects, the method comprising:
receiving, based on a user input detected by an input device, a do-for-each indicator by a target application configured to process a plurality of objects; and
in response to receiving the do-for-each indicator:
determining a first object in the plurality represented as selected on a display device,
invoking, based on the selected first object, a first operation handler to perform a first operation,
representing a second object in the plurality as selected on the display device after the first object is represented as selected, and
invoking, based on the selected second object, a second operation handler to perform a second operation.

2. The method of claim 1 wherein the do-for-each indicator is received based on a message from a remote device via a network, wherein the message is base on the user input detected by the input device.

3. The method of claim 1 wherein the do-for-each indicator identifies at least one of the first object and the second object.

4. The method of claim 1 wherein the do-for-each indicator includes a count identifying at least one of a maximum, minimum, and exact number of objects in a plurality including the first object and the second object.

5. The method of claim 1 wherein determining the first object further comprises:
determining the first object for selecting; and
representing the first object as selected on the display in response to determining the first object for selecting.

6. The method of claim 1 wherein the do-for-each indicator identifies at least one of the first operation and the second operation.

7. The method of claim 1 wherein at least one of the first operation and the second operation is identified based on an attribute of at least one of the first object and the second object.

8. The method of claim 1 further comprising receiving, based on a second user input detected by an input device, an operation indicator.

9. The method of claim 8 wherein at least one of the first operation and the second operation is identified by the operation indicator.

10. The method of claim 8 wherein the do-for-each indicator is received at least one of within a first specified time period before receiving the operation indicator, simultaneously with the operation indicator, and within a second specified time period after receiving the operation indicator.

11. The method of claim 1 further receiving the do-for-each indicator comprises:
detecting a do-for-each mode is active;
receiving, based on the user input detected by the input device, an input indicator; and
identifying the input indicator as the do-for-each indicator based on detecting the do-for-each mode is active.

12. The method of claim 11 further wherein the input indicator is an operation indicator.

13. The method of claim 12 further comprising:
in response to receiving the operation indicator and the do-for-each indicator:
determining a second first object, in a second plurality of objects, represented as selected on a display device by the target application;
identifying the second first object to a second first operation handler to perform a second first operation;
representing a second second object in the second plurality as selected on the display after the second first object is represented as selected, and
identifying the second second object to a second second operation handler to perform a second second operation after identifying the second first object to the second first operation handler.

14. The method of claim 11 further comprising:
receiving an end mode indicator; and
setting the mode of operation to end the do-for-each mode in response to receiving the end mode indicator.

15. The method of claim 14 wherein receiving the end mode indicator includes at least one of receiving the end mode indicator based on a user input detected by an input device, an expiration of a timer, a detecting of a specified time, a change in state of the target application, and a message received via a network.

16. A method for automating operating on a plurality of objects, the method comprising:
receiving, based on a user input detected by an input device, a do-for-each indicator;
identifying a target application for the do-for-each indicator; and
instructing, in response to receiving the do-for-each indicator, the target application to perform an operation on each object in a plurality of objects while each object is sequentially represented, on a display device, as selected.

17. The method of claim 16 wherein the instructing comprises invoking the target application only once.

18. The method of claim 16 wherein the instructing comprises;
invoking the target application a first time to perform said operation on said each object in a first portion of the plurality of objects while said each object in the first portion is sequentially represented as selected.
invoking the target application a second time to perform said operation on said each object in a second portion of the plurality of objects while the second portion is sequentially represented as selected.

19. A system for automating operating on a plurality of objects, the system comprising:
an execution environment including an instruction processing machine configured to process an instruction included in at least one of an input router component, an iterator component, a selection manager component, and an operation manager component;
the input router component configured for receiving, based on a user input detected by an input device, a do-for-each indicator by a target application configured to process a plurality of objects; and
the iterator component configured in to instruct, in response to receiving the do-for-each indicator,
the selection manager component configured for determining a first object in the plurality represented as selected on a display device,
the operation agent component configured for invoking, based on the selected first object, a first operation handler to perform a first operation,
the selection manager component configured for representing a second object in the plurality as selected on the display device after the first object is represented as selected, and
the operation agent component configured for invoking, based on the selected second object, a second operation handler to perform a second operation.

20. A system for automating operating on a plurality of objects, the system comprising:
an execution environment including an instruction processing machine configured to process an instruction included in at least one of an input router component and an iterator component;
the input router component configured for receiving, based on a user input detected by an input device, a do-for-each indicator;
the iterator component configured for identifying a target application for the do-for-each indicator; and
the iterator component configured for instructing, in response to receiving the do-for-each indicator, the target application to perform an operation on each object in a plurality of objects while each object is sequentially represented, on a display device, as selected.

21. A computer readable medium embodying a computer program, executable by a machine, for automating operating on a plurality of objects, the computer program comprising executable instructions for:
receiving, based on a user input detected by an input device, a do-for-each indicator by a target application configured to process a plurality of objects;
in response to receiving the do-for-each indicator:
determining a first object in the plurality represented as selected on a display device;
invoking, based on the selected first object, a first operation handler to perform a first operation;
representing a second object in the plurality as selected on the display device after the first object is represented as selected; and
invoking, based on the selected second object, a second operation handler to perform a second operation.

22. A computer readable medium embodying a computer program, executable by a machine, for automating operating on a plurality of objects, the computer program comprising executable instructions for:
receiving, based on a user input detected by an input device, a do-for-each indicator;
identifying a target application for the do-for-each indicator;
instructing, in response to receiving the do-for-each indicator, the target application to perform an operation on each object in a plurality of objects while each object is sequentially represented, on a display device, as selected.
